(19) United States
(12) Patent Application Publication
(10) Pub. No.: US 2010/0212471 A1
(43) Pub. Date: Aug. 26, 2010

(54) CUTTING TOOL FOR CUTTING LABELS

(76) Inventor: Thomas Lang, Altenthann (DE)

Correspondence Address: HAYES SOLOWAY P.C., 3450 E. SUNRISE DRIVE, SUITE 140, TUCSON, AZ, 85718, US

(21) Appl. No.: 12/709,121

(22) Filed: Feb. 19, 2010

(30) Foreign Application Priority Data
Feb. 20, 2009 (DE) 10 2009 009 820.8

(51) Int. Cl. B26D 7/26

(52) U.S. Cl. 83/698.31; 83/698.41

(57) ABSTRACT

The invention relates to a cutting tool (1), in particular for cutting labels, comprising a housing (2) which is arranged such as to be able to rotate about an axis of rotation (X), and a cutting element (4) which is arranged on this housing (2), wherein this cutting element (4) has a cutting edge (6) which extends essentially in a direction parallel to the axis of rotation (X), and wherein this cutting element (4) is detachably arranged in a recess (14) of the housing (2) formed by a plurality of walls (2a, 2b, 2c) of the housing (2), with a loading body (12) arranged in the recess (8) which loads the cutting element (4) in a working mode in a loading direction (P) in order to hold the cutting element on the housing, and with a springing element (20) which exerts a force on the loading body (12) in the loading direction (P) in the working mode of the cutting tool, and wherein a movement of the loading body (12) in the loading direction (P) is guided by a guide surface (F) and this guide surface runs in a plane (E) which is defined by a longitudinal direction (L) of the cutting element (4) and the loading direction (P). According to the invention, the guide surface (F) is the only guide surface (F) running in the plane (E) which guides the movement of the loading body (12) in the loading direction (P).

The present invention relates to a cutting tool, in particular for cutting labels. In the beverage-producing industry, it is customary that containers for beverages are provided with labels. It is known both for self-adhesive labels to be applied to the containers and also for labels to be affixed to the containers by means of a glue. In both cases, these labels can be unwound from rolls, then cut and applied in this cut form to the container.

For this purpose, various cutting devices for cutting these labels are known from the prior art. In one customary variant of such cutting tools, a cutting rotor is provided which cooperates with a roller and cuts the labels in each case at predefined spacings. To this end, cutting blades are fitted on or clamped to this cutting rotor. Due to imprecise positioning of these cutting blades, these cutting blades may quickly become worn on one side during operation. The changeover times for such cutting blades are often also considerable in apparatuses known from the prior art.

DE 4209752 C2 discloses an apparatus for cutting material. In this case, one cutting blade is provided as well as two clamping strips of complementary shape which engage in one another and which are forced apart by an expandable medium, with the cutting blade being clamped in place as a result of these two clamping strips being forced apart. However, this apparatus is relatively complicated to handle, since the two strips placed inside one another must be very precisely adjusted to one another in order on the one hand to achieve precise guidance and on the other hand to prevent any tilting of these two strips relative to one another.

The German patent application 10 2007 058 816 by the applicant, which is as yet unpublished, likewise discloses a cutting tool in which a cutting element is clamped in a cutting rotor, wherein to this end a loading body is loaded by a suitable springing element which can be filled with air. This loading body engages behind a region of the cutting rotor and is therefore guided in its movement direction on a plurality of guide surfaces. In this way, a relatively stable hold of this movement element is achieved, but on the other hand jamming may also occur and replacement of this movement body is very complicated since to this end firstly the housing of the cutting tool itself must be removed. Furthermore, this procedure also requires a multi-part design of the housing.

The object of the present invention is therefore to provide a cutting tool which is less expensive to produce and of simpler construction in comparison to the described prior art. This is achieved according to the invention by a cutting tool according to claim 1. Advantageous embodiments and further developments form the subject matter of the dependent claims.

A cutting tool according to the invention, in particular for cutting labels, comprises a housing which is arranged such as to be able to rotate about an axis of rotation, and a cutting element which is arranged on this housing, wherein this cutting element has a cutting edge which extends essentially in a direction parallel to the axis of rotation. Furthermore, this cutting element is detachably arranged in a recess of the housing formed by a plurality of walls of the housing.

Also provided in the recess is a loading body which loads the cutting element in a working mode in a loading direction in order to hold the cutting element on the housing, and also a springing element which exerts a force on the loading body in the loading direction in the working mode of the cutting tool. This loading body is guided by a guide surface relative to the housing, and this guide surface runs in a plane, to which the axis of rotation is parallel.

According to the invention, the guide surface is the only guide surface running parallel to the axis of rotation which guides the movement of the loading body in the loading direction P relative to the housing.

Advantageously, said plane is parallel to a plane which is defined by the loading direction and the axis of rotation.

The housing is in particular the so-called cutting rotor, on which at least one cutting element and preferably two or more cutting elements are arranged. The cutting element is preferably loaded—in particular continuously—towards just one wall of the recess.

The recess at which the cutting element is arranged is advantageously located on an outer circumference of the housing and is open in a direction pointing radially outwards.

The loading body is in particular a clamping strip which serves for clamping the cutting element. The springing element is in particular an expandable springing element for clamping the cutting element. The guide surface guides the movement of this loading body for clamping the cutting element. In the case of the above-described document DE 42 752 C2, two strips which engage in one another are provided, i.e. there are in this regard at least two guide surfaces which run parallel to the axis of rotation, resulting in a relatively complicated structure overall.

For instance, in the case of DE 42 09 752 C2, there are arranged in the recess, in addition to the cutting element itself, at least three elements which are separate from one another, namely the clamping strips which engage in one another and also the springing device arranged between these clamping strips. This structure is thus also relatively complicated in terms of assembly. Also in the case of the internal prior art, two guide surfaces which are parallel to one another are provided, between which the loading body, which is in this case L-shaped, is guided.

Surprisingly, a large number of experiments have shown that the L-shaped design which was originally assumed to be necessary for stabilising the loading body and thus also the cutting element is not absolutely necessary, but rather a suitable stabilisation of the loading body and also of the cutting element can be achieved even with just one guide surface. The advantages of the embodiment according to the invention lie in an easier production of the system as a whole.

In one advantageous embodiment, the recess is formed by a plurality of walls of the housing and these walls are formed in one piece with one another. Here too, therefore, the recess is of much simpler design than in the above-cited prior art, since neither complementary strips nor a two-part or multi-part recess are provided.

In a further advantageous embodiment, a pressure piece made from a deformable material is arranged between the cutting element and a wall of the recess. This pressure piece is preferably supported against a wall of the recess and serves for loading the cutting element and thus for clamping the latter. Preferably, this pressure piece is a rubber pressure piece.

In a further advantageous embodiment, the pressure piece is arranged in a recess provided in one of the walls.

In a further advantageous embodiment, a guide element which can be separated from the housing and which forms the guide surface is arranged in the recess of the housing. It is thus possible to provide in the recess on the one hand fit plates and also said guide element, which is replaceable in particular in the event of wear.

Preferably, this guide element or another element in the recess is made from an elastomer or a flexible material. In this way, this guide element also performs damping functions for those forces which act on the cutting blade in the radial direction. Greater care of the cutting element can be taken as a result of this type of damping.

In the case of DE 10 2007 058816, a further pressure cushion is provided instead of this guide element. However, it has been found that the solution now proposed is on the one hand less expensive and on the other hand is also more suitable since said elastomer is flexible but permits only limited movements of the cutting element in the radial direction. This flexible element is in particular parallel to the bottom wall of the recess and thus extends parallel to the abovementioned guide surface.

In a further advantageous embodiment, the springing element is integrated in one of the walls of the housing. However, it would also be possible for the springing element to be integrated in the loading body itself or in a recess of the loading body.

In a further advantageous embodiment, at least one region of the springing element can be expanded or moved by a gaseous medium. This means that the springing element may be for example an inflatable element or an expandable chamber which expands when acted upon by the gaseous medium, in particular by air. Besides this, however, the springing element may also be a piston which is movable in a recess in order in this way to load the loading body.

Preferably, the cutting element is supported relative to the loading body on at least two surfaces which are not parallel to one another. Preferably, the cutting element is supported relative to the loading body on two surfaces which are perpendicular to one another. These two surfaces can in this case form a step, against which the cutting element bears.

In a further advantageous embodiment, the loading body has a groove which is flexible in the loading direction and in which the cutting element is arranged. Therefore, by loading this groove, which may be formed for example by a main body of the loading body and a flexible web, the cutting element can be clamped in the loading body.

In a further advantageous embodiment, the springing element has a flexible membrane. In addition, the cutting tool preferably has a supply device for supplying the springing element with gas.

Furthermore, in one advantageous embodiment, the cutting tool has a plurality of springing elements arranged one behind the other in the direction of the axis of rotation.

Further advantages and embodiments will emerge from the appended drawings:

In the drawings:

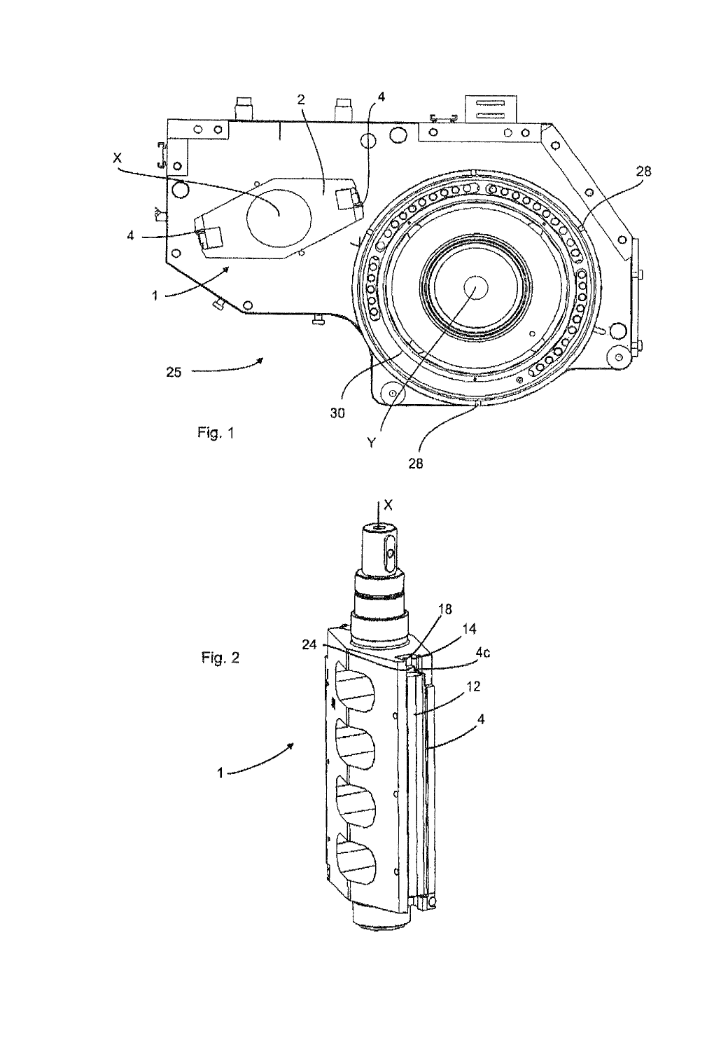

FIG. 1 shows a schematic view of an arrangement according to the invention for cutting label strips;

FIG. 2 shows a perspective view of a cutting tool according to the invention;

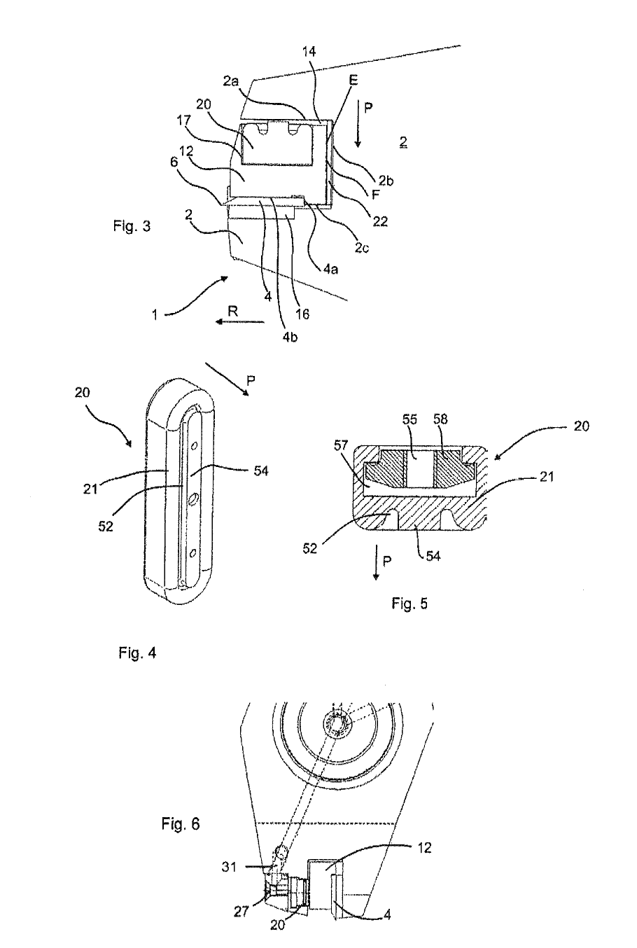

FIG. 3 shows a detail view of the cutting tool of FIG. 2;

FIG. 4 shows a perspective view of a springing element;

FIG. 5 shows a sectional view of the springing element of FIG. 4;

FIG. 6 shows a further embodiment of a cutting tool according to the invention;

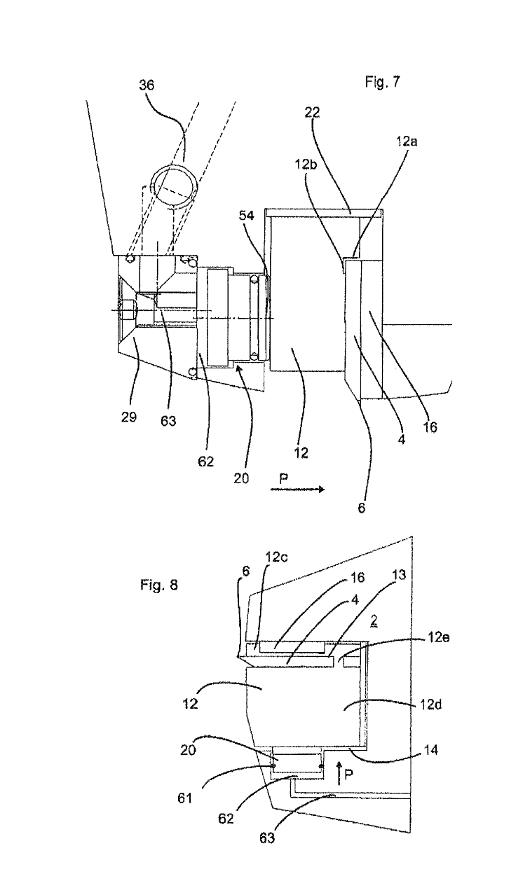

FIG. 7 shows a more detailed view of the cutting tool shown in FIG. 6; and

FIG. 8 shows a further embodiment of a cutting tool according to the invention.

FIG. 1 shows a schematic view of an apparatus 25 according to the invention for cutting labels. Here, a cutting roller is provided which initially carries an endless label strip. This cutting roller 30 comprises a plurality of counter-cutting bars 28 which are distributed in the circumferential direction of the cutting roller 30. Furthermore, the cutting roller 30 has suction devices for drawing the label against the outer circumference of the cutting roller 30. During operation, the cutting roller 30 rotates in a predefined direction of rotation about an axis of rotation Y, in this case for example in the anticlockwise direction.

Reference 1 denotes a cutting tool according to the invention which cooperates with the cutting roller 30 in order to cut the labels. More specifically, the rotation of the cutting rotor or housing 2 of the cutting tool 1 is synchronised with the rotation of the cutting roller 30 in such a way that the cutting elements 4 in each case meet the counter-cutting bars 28 during the movement, in order to cut the labels. Here, the cutting tool 1 has two cutting elements 4. The cutting tool 1 is driven by a motor (not shown), optionally by a linear motor drive.

FIG. 2 shows a view of a housing or rotor 2 according to the invention. In the diagram shown in FIG. 2, the housing is fully assembled, i.e. the cutting blade 4 and a loading body 12 are also already arranged on the housing. Reference 14 denotes a recess of the housing, in which the cutting blade 4 and the loading body 12 are arranged. The housing 2 or the rotor is in this case arranged such as to be able to rotate about an axis of rotation X.

It can be seen that the loading body 12 is somewhat shorter than the recess 14 of the housing in the direction of the axis of rotation X. In an assembled state, limiting pieces or stops (not shown) are incorporated above and below the loading body 12, wherein these may be screwed into the housing 2 for example via a threaded bore 18. These limiting pieces (not shown) prevent the loading body 12 from being able to be displaced relative to the housing in the direction of the axis of rotation X.

It can also be seen that the cutting element 4 has a protrusion 4c extending in the direction of the axis of rotation X (and also a corresponding protrusion at the lower end), so that this cutting element is also held in the radial direction by the two limiting pieces. In this way, in the event of failure of the compressed air supply, the cutting blade can nevertheless not be spun out of the housing during the rotation. Correspondingly, a protrusion 22 which is held by the limiting pieces (not shown) is also arranged on the loading body 12, so that also the loading body 12 cannot be spun out of the housing in the event of failure of the compressed air supply.

FIG. 3 shows a partial view of a cutting tool 1 according to the invention. It is also possible to see here once again the housing 2, which in this case has three walls 2a, 2b, 2c which together form the recess 14 shown in FIG. 2. The two side walls 2a and 2c are parallel to one another, and the wall 2b is perpendicular to the two walls 2a and 2c.

Reference 4 denotes the cutting element which has a cutting edge 6 that protrudes from the housing 2 in a radial direction R. This cutting element 4 is held between a pressure piece 16 and the loading body 12. To this end, the loading body is urged in a loading direction P.

Reference 20 denotes here a springing element or clamping element which, in the embodiment shown in FIG. 3, is arranged in a recess 17 of the loading body 12. By virtue of this arrangement of the springing element 20 in the recess 17, a stability of the entire arrangement is achieved in a particularly advantageous manner. This springing element 20 can expand in the loading direction P and can press a region of the springing element 20 against the wall 2a, in order conversely to exert a force on the cutting element 4 in the direction P.

During operation, this springing element 20 is continuously under pressure so that said force is continuously exerted on the cutting element 4.

The loading body 12 is thus displaceable at least slightly relative to the recess 14 or the wall 2b in the direction of the arrow P.

Between a guide element 22, which in this case bears against the wall 2b by means of fit discs (not shown), the loading element 12 is guided along a guide surface F, wherein this guide surface F is formed here by the loading direction P and a direction perpendicular to the plane of the figure, which is in turn parallel to the axis of rotation X shown in FIG. 2. Reference E denotes the plane in which the guide surface F is located. A further guide surface between the loading body 12 and the recess 14 for guiding the loading body in the direction P is not provided, but it has been found, as mentioned above, that such a further guide surface is also not necessary. As shown, stops may be provided on the respective end faces of the housing, which stops prevent the loading body 12 from being displaced relative to the housing 2 in the direction of the axis of rotation X.

The cutting element 4 bears with two side faces 4a and 4b against the loading body 12 and is thus arranged in a step of the loading body 12.

It can be seen that in the embodiment shown in FIG. 3 the recess is formed in one piece, once again resulting in a simplification of the cutting tool 1.

FIG. 4 shows a perspective view of a springing element 20. This springing element has a peripheral groove 52 which joins a main body 21 of the springing element to a flexible membrane 54. This groove makes it possible for the flexible membrane 54 to move in the direction P during an expansion of the springing element.

It would be possible for a plurality of such springing elements 20 to be arranged one behind the other in the direction of the axis of rotation X.

FIG. 5 shows a sectional view of a springing element 20. In addition to the flexible membrane 54, the peripheral groove is also shown again here. Moreover, the springing element has a cavity 57 in which an air application body 58 is sealingly placed. Via a supply line 55, air can be supplied to the springing element 20 and in this way the flexible membrane 54 can be pushed out in the downward direction in FIG. 5.

FIG. 6 shows a further schematic view of a cutting tool according to the invention. It is possible to see here an attachment means 27, such as a screw, which serves for attaching a cover 29 to a side wall of the recess 14. This cover 29 prevents the escape of compressed air. Reference 31 denotes an air supply line for supplying compressed air to the springing element 20. In this embodiment too, just one guide surface F is provided between the loading body 12 and the recess 14.

FIG. 7 shows an enlarged view of the cutting tool shown in FIG. 6. In this embodiment, the springing element 20 is designed as a piston-like element which is movable within a piston chamber 62. Via a supply line 63, compressed air is supplied to this piston chamber 62 and in this way a contact surface of this piston can be moved in the direction P and thus the loading body 12 can be prestressed in order to clamp the cutting element 4. It can be seen that the loading body forms two gaps 12a and 12b between itself and the cutting element 4.

Furthermore, it would also be possible for the loading body to be sprung in the radial direction R by a further springing element, which may be a further element that can be expanded by compressed air. This further expandable element could in this case be arranged between the guide element 22 and the wall 2b of the recess 14. Reference 36 denotes a supply line for continuously supplying air to the piston 20. A corresponding supply line could also be provided in the case of a springing element configured differently.

FIG. 8 shows a schematic view of a further embodiment of a cutting tool according to the invention. Here too, the loading body 12 is loaded by a piston 20 which is movable as the springing element 20 in the direction P, more specifically a piston which is movable relative to a chamber 62. Reference 61 denotes sealing devices for sealing off the chamber 62. Via a supply line 63, the chamber 62 can be continuously pressurised as mentioned above.

The loading body 12 here has a groove 13, in which the cutting element is arranged. More specifically, during a loading of the loading body 12 in the direction P, a web 12c of the loading body is pressed against a main body 12d of the loading body and in this way the cutting element 4 is clamped between these two elements. Here too, a pressure piece 16 is again provided, which is supported against the wall 2a of the recess 14. Said web 12c is in this case connected to the main body 12d via a transverse connection 12e, resulting in a relatively unhindered mobility of this web 12c for clamping purposes. In this embodiment, too, the loading body 12 has just one guide surface for guiding the movement relative to the recess 14 in the direction P.

All of the features disclosed in the application documents are claimed as essential to the invention in so far as they are novel individually or in combination with respect to the prior art.

### LIST OF REFERENCES

1 cutting tool
2 housing or cutting rotor
2a, 2b, 2c walls
4 cutting element
4a, 4b side faces
4c protrusion
6 cutting strip
12 loading body
12a, 12b gaps
12c web
12d main body
12e transverse connection
13 groove
14 recess
16 pressure piece
17 recess
18 threaded bore
20 springing element
21 main body
22 guide element
24 protrusion
27 attachment means
28 counter-cutting bars
29 cover
30 cutting roller
36 air supply line
52 groove
54 flexible membrane
55 supply line
57 cavity
58 air application body
61 sealing device
62 piston chamber
63 supply line
E plane
F guide surface
P loading direction
R direction, radial
X, Y axis of rotation
L longitudinal direction

1. Cutting tool (1), in particular for cutting labels, comprising a housing (2) which is arranged such as to be able to rotate about an axis of rotation (X), and a cutting element (4) which is arranged on this housing (2), wherein this cutting element (4) has a cutting edge (6) which extends essentially in a direction parallel to the axis of rotation (X), and wherein this cutting element (4) is detachably arranged in a recess (14) of the housing (2) formed by a plurality of walls (2a, 2b, 2c) of the housing (2), with a loading body (12) arranged in the recess (8) which loads the cutting element (4) in a working mode in a loading direction (P) in order to hold the cutting element on the housing, and with a springing element (20) which exerts a force on the loading body (12) in the loading direction (P) in the working mode of the cutting tool, and wherein a movement of the loading body (12) in the loading direction (P) is guided by a guide surface (F) and this guide surface runs in a plane (E), to which the axis of rotation (X) is parallel, wherein the guide surface (F) is the only guide surface (F) running in the plane (E) which guides the movement of the loading body (12) in the loading direction (P).

2. Cutting tool according to claim 1, wherein the recess (14) is formed by a plurality of walls (2a, 2b, 2c) of the housing (2) and these walls (2a, 2b, 2c) are formed in one piece with one another.

3. Cutting tool (1) according to claim 1, wherein a pressure piece (16) made from a deformable material is arranged between the cutting element (4) and a wall (2a) of the recess (14).

4. Cutting tool (1) according to claim 3, wherein the pressure piece (16) is arranged in a recess provided in one of the walls (2a, 2b, 2c).

5. Cutting tool (1) according to claim 1, wherein a guide element (22) which can be separated from the housing (2) and which forms the guide surface (F) is arranged in the recess (14).

6. Cutting tool according to claim 1, wherein the guide element (22) or a further element arranged in the recess (14) of the housing (2) is made from a flexible material.

7. Cutting tool (1) according to claim 1, wherein the springing element (20) is integrated in one of the walls (2a, 2b, 2c) of the housing.

8. Cutting tool (1) according to claim 1, wherein at least one region of the springing element (20) can be moved by a gaseous medium.

9. Cutting tool (1) according to claim 1, wherein the cutting element (4) is supported relative to the loading body (12) on at least two surfaces which are not perpendicular to one another.

10. Cutting tool (1) according to claim 1, wherein the loading body (12) has a groove (13) which is flexible in the loading direction (P) and in which the cutting element (4) is arranged.

11. Cutting tool (1) according to claim 1, wherein the springing element (20) has a flexible membrane (54).

12. Cutting tool (1) according to claim 1, wherein the cutting tool (1) has a supply device for supplying the springing element with gas.

13. Cutting tool (1) according to claim 1, wherein the cutting tool has a plurality of springing elements (20) arranged one behind the other in the direction of the axis of rotation.
